(19) United States
(12) Patent Application Publication
(10) Pub. No.: US 2001/0030946 A1
(43) Pub. Date: Oct. 18, 2001

(54) Method of capturing utilization charges

(76) Inventors: Olaf Bohme, Berlin (DE); Uve Reimer, Berlin (DE)

Correspondence Address: LERNER AND GREENBERG, P.A., Post Office Box 2480, Hollywood, FL, 33022-2480, US

(21) Appl. No.: 09/836,814

(22) Filed: Apr. 17, 2001

(30) Foreign Application Priority Data
Apr. 17, 2000 (DE) 100 19 000.6

(51) Int. Cl. H04J 1/16; H04J 3/14

(52) U.S. Cl. 370/252

(57) ABSTRACT

In order to capture utilization charges in a packet data transmission network, a recording is made of the charges that become payable during the course of a transmission session, when a threshold charge-total is reached. It is preferable if the value of the threshold charge-total varies depending on the data speed of the transmission session.

### BACKGROUND OF THE INVENTION

1. Field of the Invention

The present invention relates to a method for capturing utilization charges in a packet data transmission network.

Data transfer in packet data transmission networks is a continuous process, and is heavily dependent on the subscriber profile or the application respectively.

Packet data transmission networks are suitable for many different applications, characterized by a wide variety of transmission activities. These include, for example, telematic applications, such as remote monitoring of technical installations where relatively small amounts of data are transmitted during the course of prolonged transmission sessions, file transfer or Internet traffic, where periods of low and high activity may alternate, and transmissions with consistently medium to high transmission speeds such as audio or video transmissions.

Data relating to subscriber transmission activity are captured in the nodes of such a packet data transmission network, for billing and statistical purposes. If the volume of data or the duration of a transmission session exceeds a defined threshold, then the data are written to a non-volatile storage medium, e.g. a hard disk, in the form of data records. The storage medium can be installed in a network node or router, or elsewhere in the network (e.g. centrally). Since writing data records adversely affects the performance of packet switching, it is essential to limit the number of recording operations to an absolute minimum.

Conversely, records must be written often enough to save the data for subsequent processing. As long as the data is not saved, there is a possibility that it may be lost through a technical fault or fraudulent intervention in the system by a third party. The longer the interval between recordings, i.e. the greater the charge amount that is subsequently calculated and billed to the subscriber on the basis of recordings made, the greater the risk of (and motivation for) fraudulent intervention. It is therefore desirable to make recordings frequently, in order to minimize the associated risk of financial losses to operators of such networks.

The generation of records at fixed time intervals, which is easily practicable in a telecommunications network, is not appropriate in a packet data transmission network, since transmission speeds for different sessions may differ by several orders of magnitude, and the charge value, which corresponds to a recording and is calculated on the basis of the volume of data transferred, would vary significantly.

The frequency with which such records are generated is therefore inevitably a compromise between conflicting demands.

### SUMMARY OF THE INVENTION

The object of the present invention is to provide a method of capturing utilization charges in a packet data transmission network which overcomes the above-noted deficiencies and disadvantages of the prior art devices and methods of this general kind, and which provides low-cost facilities for generating and recording such charges that are due, yet offers a high level of security against loss of data and external intervention.

With the above and other objects in view there is provided, in accordance with the invention, a method of capturing utilization charges in a packet data transmission network, which comprises:

acquiring data relating to charges for a transmission session during the transmission session;

calculating charges that become payable during the transmission session; and

recording the calculated charges when the calculated charges exceed a threshold charge-total.

In other words, any charges that are payable are calculated during the course of a transmission session, and a record is made of charges that are payable once a charge threshold is exceeded.

This means that recordings are not made for transmission sessions with low levels of transmission activity, which only correspond to a low equivalent charge, i.e. it prevents this type of transmission session from loading the transmission network with numerous charge records that have to be processed and transmitted, if the associated costs are disproportionate to the equivalent charge.

It is also possible, for example, to allocate different charge rates to different applications depending on their transmission characteristics, and thereby tailor the frequency with which recordings are made to the financial risk of data loss.

It is particularly advantageous if the value defined for the threshold charge-total is dependent on the data speed of the transmission session.

As a rule of thumb, the lower the data speed of the transmission session, the lower the threshold charge-total. Assuming that the probability of losing data or falling victim to a fraudulent intervention is proportionate to the duration for which charge data remains unsecured, and that the anticipated damages resulting from data loss or intervention correspond to the average unsecured charge amount, i.e. approximately half the threshold charge-total, the risk for sessions with varying data speeds can be standardized to some extent by defining the threshold charge-total for each session so that the product of the threshold charge-total and the average data speed is the same for all sessions.

It is appropriate to deviate from this rule of thumb in the case of sessions with intermittent data traffic, such as file transfer or Internet access, for example. With this type of transmission session, recordings should also be generated if the data traffic is interrupted or suspended, even though the threshold charge-total has not yet been reached, since there is otherwise a danger that considerable charge amounts may remain unsecured for extended periods.

In order to determine the variable time-points of the recordings, a function is calculated in accordance with a preferred form of the method. This function depends on the transmission activity since the start of the session or since the last recording, and increases monotonously with this transmission activity. A recording is made if this function exceeds a threshold, where the threshold is a decreasing function of the time period from the start of the session or the last recording. The value of the function is directly linked to the charge amount debited to the subscriber with the recording. For the sake of simplicity, this function is subsequently referred to as the charge function.

Decreasing the threshold over the course of time ensures that, even if there is minimal transmission activity, the threshold will be exceeded after a finite period and a recording will be made. At the same time, if the transmission activity in a session terminates shortly before reaching the threshold, then the smaller the amount by which the threshold was missed, the shorter the delay before the recording is made. This means that the greater the transmission service already provided by the network operator, and therefore the greater the charge amount to be secured, the shorter the delay before the recording is made.

The transmission activity of a transmission session can be measured in bits or equally in multiples of bits. It can also be measured in packets, where the length or number of bits in a packet is not necessarily the same for all the packets in a packet data transmission system. It is also possible to consider transmission activity as a derived value calculated from the transmitted volume of information and the transmitted number of packets. Use of such a value means that charges for the transmission service of the packet transmission system are not calculated solely on the basis of the transmitted volume of information or the transmitted number of packets, but that both factors can have a weighted influence on the calculation of charges.

In order to reduce the load placed upon nodes in a packet data transmission network as a result of capturing recordings, it is also advantageous if the aforementioned charge function is calculated in a timed cycle. In order to capture charges correctly, it is not necessary for the value of the function that corresponds to the transmission activity up to the present time to be known at all times; even if there is a slight delay before the timed calculation of the function detects that the function has exceeded the threshold, this does not affect the capture of charges.

Other features which are considered as characteristic for the invention are set forth in the appended claims.

Although the invention is illustrated and described herein as embodied in a method for capturing utilization charges, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of a packet data transmission network in which the present invention can be used;

FIG. 2 is a graph illustrating the conventional method for determining the time-points at which to make recordings of charges that have become payable;

FIG. 3 is a graph illustrating a first mode of the method according to the invention; and

FIGS. 4 and 5 are respective graphs illustrating two variants of a second mode of the novel method.

### DESCRIPTION OF THE PREFERRED EMBODIMENTS

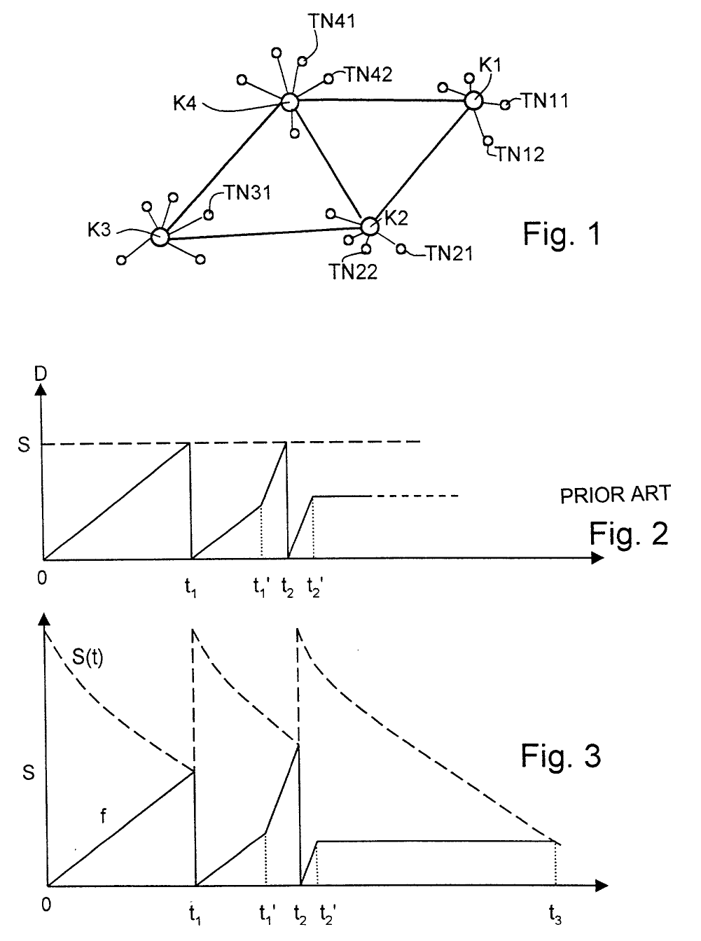

Referring now to the figures of the drawing in detail and first, particularly, to FIG. 1 thereof, there is seen a packet data transmission system that includes a number of nodes K1, K2, K3, K4, each of which is connected to at least one other node and to subscribers TN11, TN12, . . . , TN21, . . . , etc. Each individual subscriber is allocated a charge account in the form of a data storage area, in which recordings are made of the costs incurred as a result of the subscriber's transmission activities in the network. These charge accounts can be managed on a number of nodes K1, K2, etc. In particular, the charge account for each subscriber can be managed at that node to which the subscriber is connected. However, it is also possible to manage the charge accounts for all subscribers centrally on a single node or selected nodes within the network.

The capture, calculation and recording of charges adds to the workload of the individual nodes, with the result that only part of their processing power is available for switching data between subscribers. If charge accounts are managed centrally, then there is an additional load on the network since charge information must be transported through the network as well as payload data transmitted between the subscribers. This further which restricts the transmission capacity of the network.

FIG. 2 illustrates the conventional method for capturing charges. The graph shows a data volume D, measured in bits or bytes or multiples thereof, transmitted between two subscribers in a transmission session during the period of time t. At the beginning of the transmission session, at time-point t=0, the data volume is equal to zero. This increases during the course of time until it reaches a threshold S at time-point t₁. A recording is made at this time-point, and the charge account of the subscriber that initiated the session is debited with an amount that corresponds to the transmitted data volume. At the same time, the numeric value of data volume D is reset to zero. The transmitted data volume increases once again over time. The data transfer speed increases at the time-point t₁′ in the exemplary illustration. The data volume once again reaches the threshold S at the time-point t₂′, at which point a further recording is made and the numeric value of the data volume is once again reset to zero. The transmission at the higher speed terminates at the time-point t₂′, and before reaching the threshold S again. As long as no further data are transmitted, no new recording is made. As a result, the charge amount corresponding to the data volume transmitted since the last recording remains unsecured until the transmission is continued or until a new recording is made as a result of the session being terminated.

In accordance with a first form of the method, the data volumes transmitted per time unit in a session are captured, and the threshold S for the session concerned is determined as a function of the captured value. Because a lower threshold S is selected for sessions with a low level of transmission activity than for sessions with a high level of transmission activity, charges are recorded frequently enough to keep the risk of loss within acceptable limits, even in the former case (sessions with a low level of transmission activity).

The threshold can be defined if information about the session type is transmitted when a session is established, and the packet data transmission network can gauge or estimate the anticipated transmission activity for the session concerned. Ideally, the data volume transmitted per time unit is measured by the packet data transmission network, and the threshold is defined on the basis of the measured value. It is preferable if this measurement is taken throughout the transmission session, so that the measurement results obtained in the period between the start of the session and the first recording, or between two recordings, can be used to define the threshold for the next recording.

In accordance with a second form of the inventive method, FIG. 3 illustrates the definition of recording points t₁, t₂, etc. With this form of the method, it is not necessary to measure the transmission quality. A charge function f is calculated, which is a monotonously increasing function of the data transmission volume. According to a simple variant, the function f could have the format e.g. f=c₁D+c₂P, where D is the transmitted data volume in MB, P is the number of transmitted packets, and c₁ and c₂ are non-negative constants of which one may be zero. The diagram shows the profile of the charge function over time for an exemplary transmission session. As in FIG. 2, this example considers a transmission session that starts at time-point t=0, and is characterized by an initial, low, data speed between the time-points t=0 and t=t₁′, a second, higher, data speed until time-point t₂′, and a data speed of 0 after time-point t₂′.

The threshold S is a function of time t in this context. It is set to a high starting value at time-point t=0 at the beginning of each transmission session, and decreases monotonously from then. The function f(D,P) initially increases linearly from its starting value of 0 at t=0, until it reaches time-point t₁, when it crosses the time-dependent threshold S(t).

When a recording is made at time-point t₁, the charge function f is reset to the value 0 and the threshold S(t) is reset to its high starting value. The fall of threshold S(t) and the rise of charge function f(t) recommence, based on the data volume transmitted over time. The data speed of the transmission session is increased at time-point t₁′, so that the slope in the charge function f increases. The time period between t₂ and t₁ is therefore shorter than that between t₁ and t=0; the data volume transmitted in the second time period is greater than that transmitted in the first.

When the data transmission terminates at the time-point t₂′, the charge function f ceases to rise. However, the threshold S(t) continues to fall, so that the charge function once again reaches the threshold S at the time-point t₃, and a recording is made.

A recording is made when the threshold charge-total is exceeded, and the lower the average data speed of the transmission session in the time period concerned [0, t₂], [t₁, t₂], etc., the lower the threshold charge-total.

Of course, the fact that the threshold is time-dependent does not exclude the possibility that the charge function itself may also be dependent on the time in addition to the transmission volume.

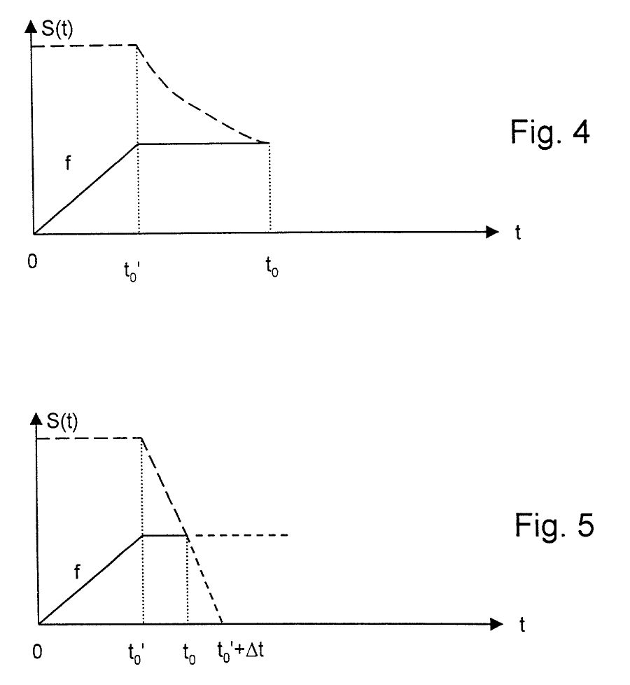

FIG. 4 illustrates a further form of the method using a graph, which shows the development of the charge function f relative to time, for an example transmission session, where there is constant transmission activity from t=0 to t=t₀′ and where transmission is interrupted at t₀′. The development of the charge function f is shown as a continuous line.

A recording is made when the threshold S is exceeded. The threshold is determined using an average derivative of the charge function relative to time (more concisely referred to as the average charge rate). The threshold S, as determined based on the average charge rate, is shown as a broken line. The average charge rate f*(t) is simply defined here as the quotient of the value of the charge function f at time-point t and the time t, i.e., f*(t)=f(t)/t, where the time is always measured from the beginning of the transmission session or from the last recording, whichever is the more recent.

In the data transmission profile shown in FIG. 4, the transmission volume increases linearly from time-point t=0 to t₀′, and f* is constant. No more data is transmitted after t₀′, as a result of which f* decreases over time in proportion to the reciprocal value of time. The threshold S also decreases proportionally, and the charge function f reaches the value of S at time-point t₁, at which point a recording is made.

Alternatively, the average charge rate can also be defined as the difference between the charge function f(t) at a present time-point t and the charge function f(t−Δt) at a time-point in the past that precedes it by a fixed period of Δt, divided by the period Δt. For the same transmission and charge-function profiles already shown in FIG. 4, this would give the threshold S profile shown in FIG. 5: When the transmission ends at time-point t₀′, the threshold S begins to decrease linearly and reaches the value 0 after a delay Δt. This is the latest point at which the charge function, irrespective of its value at time-point t₀′, will reach the threshold S and the recording is initiated.

In a simple form of the method described above, a numeric value for the transmitted bits or packets can be used directly as a charge function. Flexible tariff structures, which e.g. allow lower charges to be calculated per megabyte transmitted in the context of a high-speed transmission than in the context of a sporadic or slow transmission, nonetheless require the calculation of a charge function derived from direct numeric values. In order to limit the processing resources devoted to capturing charges, an enhanced form of the method described above does not calculate the charge function at the same time as the transmitted data is counted.

Instead, the network nodes are fitted with a timer, which triggers the calculation of a charge function for the active transmission sessions of subscribers connected to the nodes at specified time intervals, e.g. from every few minutes to every half-hour.

As a result, calculation of the charge function may reveal that the threshold has not just been met but has already been exceeded. This does not mean that the network operator will sustain any losses as a result, since the charge amount billed is not the value of the threshold, but the actual charge value that is calculated.

We claim:

1. A method of capturing utilization charges in a packet data transmission network, which comprises:
acquiring data relating to charges for a transmission session during the transmission session;
calculating charges that become payable during the transmission session; and
recording the calculated charges when the calculated charges exceed a threshold charge-total.

2. The method according to claim 1, which comprises varying a value of the threshold charge-total depending on a data speed of the transmission session.

3. The method according to claim 2, which comprises setting the threshold charge-total lower, the lower the data speed of the transmission session.

4. The method according to claim 1, which comprises, for transmission sessions with intermittent or interrupted data traffic, generating recordings before the threshold charge-total is reached if the data traffic is suspended.

5. The method according to claim 1, which comprises defining a variable threshold charge-total as a decreasing function of a time period measured from a last session start or from a last recording.

6. The method according to claim 5, which comprises calculating a monotonously increasing charge function in dependence on a data transmission volume since the last session start or the last recording, and effecting a recording if the charge function exceeds the variable threshold charge-total.

7. The method according to claim 5, which comprises measuring the data transmission volume in bits.

8. The method according to claim 5, which comprises measuring the data transmission volume in packets.

9. The method according to claim 5, which comprises calculating the data transmission volume from a volume of information transmitted and a number of packets transmitted.

10. The method according to claim 1, which comprises calculating the charges payable in a timed cycle.

11. The method according to claim 1, which comprises effecting a recording when an increase in the charge total exceeds a limit value.
